(19) United States
(12) Patent Application Publication
(10) Pub. No.: US 2014/0108097 A1
(43) Pub. Date: Apr. 17, 2014

(54) SYSTEMS AND METHODS FOR REAL-TIME PRODUCT PRICING OPTIMIZATION

(71) Applicant: CUSTOLOGIX INC., Fort Lauderdale, FL (US)

(72) Inventor: Kiran Gange, Fort Lauderdale, FL (US)

(73) Assignee: CUSTOLOGIX INC., Fort Lauderdale, FL (US)

(21) Appl. No.: 13/651,277

(22) Filed: Oct. 12, 2012

(51) Int. Cl. G06Q 30/02

(52) U.S. Cl. CPC G06Q 30/0206
USPC 705/7.35

(57) ABSTRACT

Product pricing and inventory optimization systems and methods and user interface elements enable users to optimize inventory (e.g., product quantity or volume) and pricing levels in real time for products for a given time period. Pricing and volume information is automatically determined for products in a product category for a specified time frame based on a shopping criterion defining how a merchandising set including that product is shopped by consumers and based on specified price and volume change limits. The shopping criterion may include a hierarchical order of at least two product relationship parameters, the product relationship parameters including brand relation information, size relation information, feature relation information and price relation information. In certain aspects, the pricing and volume information is also determined based on a brand hierarchy identifying an order of a set of product brands for the product category.

### BACKGROUND

The present embodiments relate generally to data optimization systems and methods and more particularly to retail product pricing and inventory level (volume or quantity) optimization systems and methods. Such systems and methods are particularly useful for companies, such as retail or wholesale sellers, that sell products or services in a competitive environment.

### BRIEF SUMMARY

Pricing optimization systems and methods that allow a user (e.g., retail store manager or other user) to optimize inventory (e.g., product quantity or volume) and pricing levels in real time for products over a given time period.

In one embodiment, pricing and volume information is automatically determined for products in a product category for a specified time frame based on a shopping criterion defining how a merchandising set including that product is shopped by consumers and specified price and volume change limits. In one embodiment, the shopping criterion includes a heirarchical order of at least two product relationship parameters, the product relationship parameters including brand relation information, size relation information, feature relation information and price relation information. In certain aspects, the brand relation information includes absolute or percentage pricing differences between different product brands, and the price relation information includes competitive retail price information. In certain aspects, the pricing and volume information is also determined based on a brand hierarchy identifying an order of a set of product brands for the product category.

According to one embodiment, a decision support system is provided to assist users with determining product pricing and volume (e.g., quantity) information e.g., retail product pricing information. The decision support system in one embodiment is configured to optimize product pricing information in real time based on product relationship parameters. The system typically includes a processor adapted to receive a first specification of product price and volume change limit parameters for a product category comprising merchandising sets of two or more product types, to receive a second specification of a shopping criterion for said product category, said shopping criterion defining how each merchandising set is shopped by consumers, to receive a time frame specification identifying a time frame in which products in said product category will be sold, and to automatically determine optimized pricing and volume information for products in said product category for said time frame based on the shopping criterion, the price and volume change limit parameters and the time frame. The various specifications (e.g., first, second and time specifications) may be input by a user, e.g., entered or selected by the same user or by different users, or programmatically based on other input. The system also typically includes a display device, wherein the processor is also further configured to cause the optimized pricing and volume information for products in said product category to be displayed on the display device.

In certain aspects, the shopping criterion includes a heirarchical order of at least two product relationship parameters, the product relationship parameters including brand relation information, size relation information, feature relation information and price relation information. In certain aspects, the brand relation information specifies absolute or percentage pricing differences between different product brands. In certain aspects, the price relation information includes competitive retail price information. In certain aspects, the shopping criterion comprises a heirarchical order of at least three of said product relationship parameters. In certain aspects, the processor is further adapted to receive brand hierarchy information such as a specification of a brand hierarchy identifying an order of a set of product brands for said product category, wherein determining optimized pricing and volume information is further based on the brand hierarchy information.

In certain aspects, the processor is further adapted to modify in real time the displayed optimized price and volume information for products (some or all products) in the product category responsive to receiving an adjustment (e.g., a user input adjustment) of the displayed optimized pricing and volume information for one or more of the products. In certain aspects, the processor is further adapted to receive input indicating a lock on changes for one or more of the displayed products, wherein modifying includes modifying the optimized price and volume for all but the one or more locked products.

In another embodiment, a computer-implemented method is provided for optimizing product pricing information in real time. The method typically includes the steps, implemented in a processor, of receiving a specification) of product price and volume change limit parameters for a product category comprising merchandising sets of two or more product types, of receiving a specification of a shopping criterion defining how each merchandising set is shopped by consumers for the product category and of receiving a time frame specification identifying a time frame in which products in the product category are to be sold. The method also typically includes automatically determining optimized pricing and volume information for products in the product category for the time frame based on the shopping criterion, the price and volume change limit parameters and the time frame. The method also typically includes causing the optimized pricing and volume information for products in said product category to be displayed, e.g., on a display device or using a display device. In certain aspects, the shopping criterion includes a heirarchical order of at least two product relationship parameters, the product relationship parameters including brand relation information, size relation information, feature relation information and price relation information. In certain aspects, the brand relation information specifies absolute or percentage pricing differences between different product brands. In certain aspects, the price relation information includes competitive retail price information. In certain aspects, the shopping criterion comprises a heirarchical order of at least three of said product relationship parameters. In certain aspects, the processor is further adapted to receive brand hierarchy information such as a specification of a brand hierarchy identifying an order of a set of product brands for said product category, wherein determining optimized pricing and volume information is further based on the brand hierarchy information.

In yet another embodiment, a computer-implemented method is provided for displaying optimized pricing and volume information for products in a product category. The method typically includes displaying, e.g., on or using a display device, a change limit parameter selection tool for adjusting product price and volume change limit parameters for a product category comprising merchandising sets of two or more product types, a shopping criterion tool for selecting a shopping criterion for said product category, said shopping criterion defining how each merchandising set is shopped by consumers, and a time frame selection tool for selecting a time frame in which products in said product category are to be sold. The method also typically includes displaying optimized pricing and volume information for products in the product category for a time frame, the optimized pricing and volume information being automatically determined based on a selected shopping criterion, selected price and volume change limit parameters and a selected time frame.

In certain aspects, the shopping criterion includes a heirarchical order of at least two product relationship parameters, the product relationship parameters including brand relation information, size relation information, feature relation information and price relation information. In certain aspects, the brand relation information specifies absolute or percentage pricing differences between different product brands. In certain aspects, the price relation information includes competitive retail price information. In certain aspects, the shopping criterion comprises a heirarchical order of at least three of said product relationship parameters. In certain aspects the method further includes, for the product category, displaying a brand hierarchy selection tool for selecting a brand hierarchy identifying an order of a set of product brands, wherein said optimized pricing and volume information is further determined based on the brand hierarchy.

In certain aspects, the method further includes modifying in real time the displayed optimized price and volume information for some or all products in the product category responsive to receiving an adjustment of the displayed optimized pricing and volume information for one or more of the products. In certain aspects, the method further includes receiving input indicating a lock on changes for one or more of the products, wherein modifying includes modifying the optimized price and volume for all but the one or more locked products.

In certain aspects, the product price and volume change limit parameters include a maximum allowed percentage increase and a maximum allowed percentage decrease for each of a price and a volume of a product in the product category.

Reference to the remaining portions of the specification, including the drawings and claims, will realize other features and advantages of the various embodiments disclosed herein. Further features and advantages of the various embodiments, as well as the structure and operation of various embodiments, are described in detail below with respect to the accompanying drawings. In the drawings, like reference numbers indicate identical or functionally similar elements.

### BRIEF DESCRIPTION OF THE SEVERAL VIEWS OF THE DRAWING(S)

FIGS. 1a and 1b illustrate a price and volume optimization system according to one embodiment.

FIG. 2 illustrates a pricing optimization process according to one embodiment.

FIG. 3 illustrates a user administration display screen according to one embodiment.

FIGS. 4a-4e illustrate a company level dashboard display according to one embodiment.

FIG. 5 illustrates a strategy configuration screen display according to one embodiment.

FIG. 6 illustrates a strategy configuration screen display including change limit selectors according to one embodiment.

FIGS. 7a-7g illustrate a product category configuration screen display according to one embodiment.

FIG. 8 illustrates a price and volume configuration screen display according to one embodiment.

FIG. 9 illustrates a pricing optimization modification screen display according to one embodiment.

FIG. 10 illustrates a pricing optimization modification screen display with a pop-up overlay according to one embodiment.

FIG. 11 illustrates a pricing optimization modification screen display with a pull-down overlay according to one embodiment.

FIG. 12 illustrates an activity display screen according to one embodiment.

### DETAILED DESCRIPTION

Product pricing and inventory optimization systems and methods are provided that allow a user to optimize inventory (e.g., product quantity or volume) and pricing levels in real time for products for a selected time period.

Pricing and volume information is automatically determined for products in a product category for a specified time frame based on a shopping criterion defining how a merchandising set including that product is shopped by consumers and specified price and volume change limits. In one embodiment, the shopping criterion includes a heirarchical order of at least two product relationship parameters, the product relationship parameters including brand relation information, size relation information, feature relation information and price relation information. In certain aspects, the pricing and volume information is also determined based on a brand hierarchy identifying an order of a set of product brands for the product category.

### System Configuration

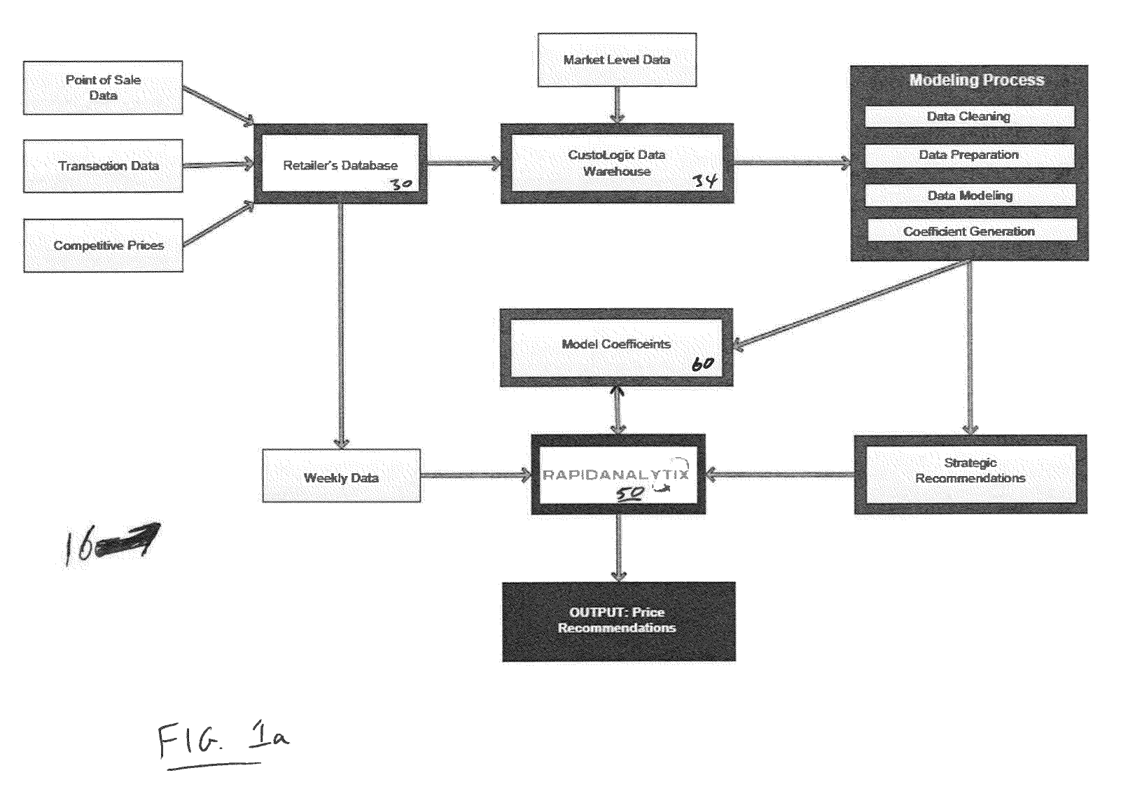

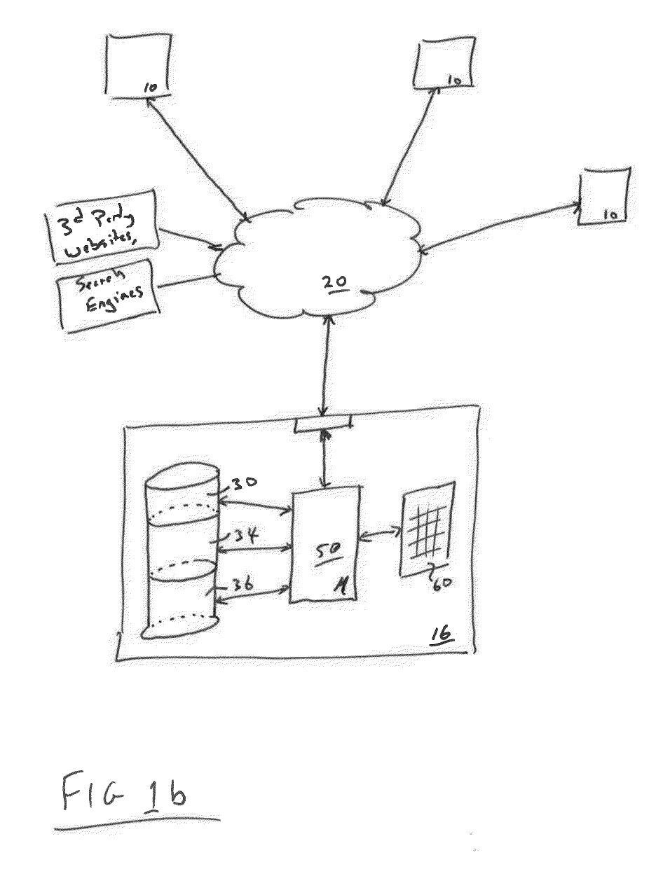

FIG. 1a illustrates a price and volume optimization system 16, and FIG. 1b illustrates an environment in which the price and volume optimization system is implemented according to one embodiment.

FIG. 1b illustrates an environment of a pricing and volume optimization system. As illustrated in FIG. 1b any user systems 10 might interact via a network 20 with pricing and volume optimization system (POS) 16. The users of those user systems 10 might be users in differing capacities and the capacity of a particular user system 10 might be entirely determined by the current user. For example, where an administrative user is using a particular user system 10 to interact with POS 16, that user system has the capacities allotted to that administrative user. However, while a user in a different role is using that user system to interact with POS 16, that user system has the capacities allotted according to the privileges and permissions allocated to that role.

Network 20 can be a LAN (local area network), WAN (wide area network), wireless network, point-to-point network, star network, token ring network, hub network, or other configuration. As the most common type of network in current use is a TCP/IP (Transfer Control Protocol and Internet Protocol) network such as the global internetwork of networks often referred to as the “Internet” with a capital “I,” that will be used in many of the examples herein, but it should be understood that the networks that the present invention might use are not so limited, although TCP/IP is the currently preferred protocol.

User systems 10 might communicate with POS 16 using TCP/IP and, at a higher network level, use other common Internet protocols to communicate, such as HTTP, FTP, AFS, WAP, etc. As an example, where HTTP is used, user system 10 might include an HTTP client commonly referred to as a “browser” for sending and receiving HTTP messages from an HTTP server at POS 16. Such HTTP server might be implemented as the sole network interface between POS 16 and network 20, but other techniques might be used as well or instead.

In certain aspects, the system shown in FIG. 1b implements a retail product pricing and inventory optimization protocol or algorithm. For example, in one aspect, POS 16 can include application servers configured to implement and execute software applications as well as provide related data, code, forms, web pages and other information to and from user systems 10 and to store to, and retrieve from, a database system related data, objects and web page content related to retail product pricing and inventory levels.

One arrangement for elements of POS 16 is shown in FIG. 1b, including a storage 30 for data received from retailers, storage 34 for market level data accessible to POS 16 and storage 36 for program code for implementing various functions of POS 16, and a process space 50 for executing POS system processes, such as cleaning and preparing data, data modeling and coefficient generation and running applications as part of an application service.

Several elements in the system shown in FIG. 1b include conventional, well-known elements that need not be explained in detail here. For example, each user system 10 could include a desktop personal computer, workstation, laptop, PDA, cell phone, or any WAP-enabled device or any other computing device capable of interfacing directly or indirectly to the Internet or other network connection. User system 10 typically runs an HTTP client, e.g., a browsing program, such as Microsoft's Internet Explorer™ browser, Mozilla'sFirefox™ browser, Opera's browser, or a WAP-enabled browser in the case of a cell phone, PDA or other wireless device, or the like, allowing a user of user system 10 to access, process and view information and pages available to it from POS 16 over network 20. Each user system 10 also typically includes one or more user interface devices, such as a keyboard, a mouse, touch screen, pen or the like, for interacting with a graphical user interface (GUI) provided by the browser on a display (e.g., monitor screen, LCD display, etc.) in conjunction with pages, forms and other information provided by POS 16 or other systems or servers. As discussed above, the present invention is suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 10 and all of its components are operator configurable using applications, such as a browser, including computer code run using a central processing unit such as an Intel Pentium processor or the like. Similarly, POS 16 (and additional instances of POS's, where more than one is present) and all of their components might be operator configurable using application(s) including computer code run using a central processing unit such as an Intel Pentium processor or the like, or multiple processor units. Computer code for implementing product pricing and inventory optimization algorithms in POS 16, including computer code for operating and configuring POS 16 to intercommunicate and to process web pages and other data and media content as described herein is preferably downloaded and stored on a hard disk, but the entire program code, or portions thereof, may also be stored in any other volatile or non-volatile memory medium or device as is well known, such as a ROM or RAM, or provided on any media capable of storing program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing various aspects disclosed herein, including the product pricing and inventory optimization algorithms, can be implemented in any programming language that can be executed on a server or server system such as, for example, in C, C++, HTML, Java, JavaScript, any other scripting language, such as VBScript and many other programming languages as are well known.

According to one embodiment, each POS 16 is configured to provide web pages, forms, data and media content to user systems 10 to support the access by user systems 10 as subscribers of POS 16. As such, POS 16 provides security mechanisms to keep each user's data secure. If more than one POS is used, they may be located in close proximity to one another (e.g., in a server farm located in a single building or campus), or they may be distributed at locations remote from one another (e.g., one or more servers located in city A and one or more servers located in city B). As used herein, each POS could include one or more logically and/or physically connected servers distributed locally or across one or more geographic locations. Additionally, the term “server” is meant to include a computer system, including processing hardware and process space(s), and an associated storage system and database application (e.g., RDBMS) as is well known in the art. It should also be understood that “server system” and “server” are often used interchangeably herein. Similarly, the databases described herein can be implemented as single databases, a distributed database, a collection of distributed databases, a database with redundant online or offline backups or other redundancies, etc., and might include a distributed database or storage network and associated processing intelligence. As one example POS 16 could be implemented on Amazon.com's cloud service, Amazon Web Services, which provides processing, storage and server functionality on the “cloud.”

### General Process Flow

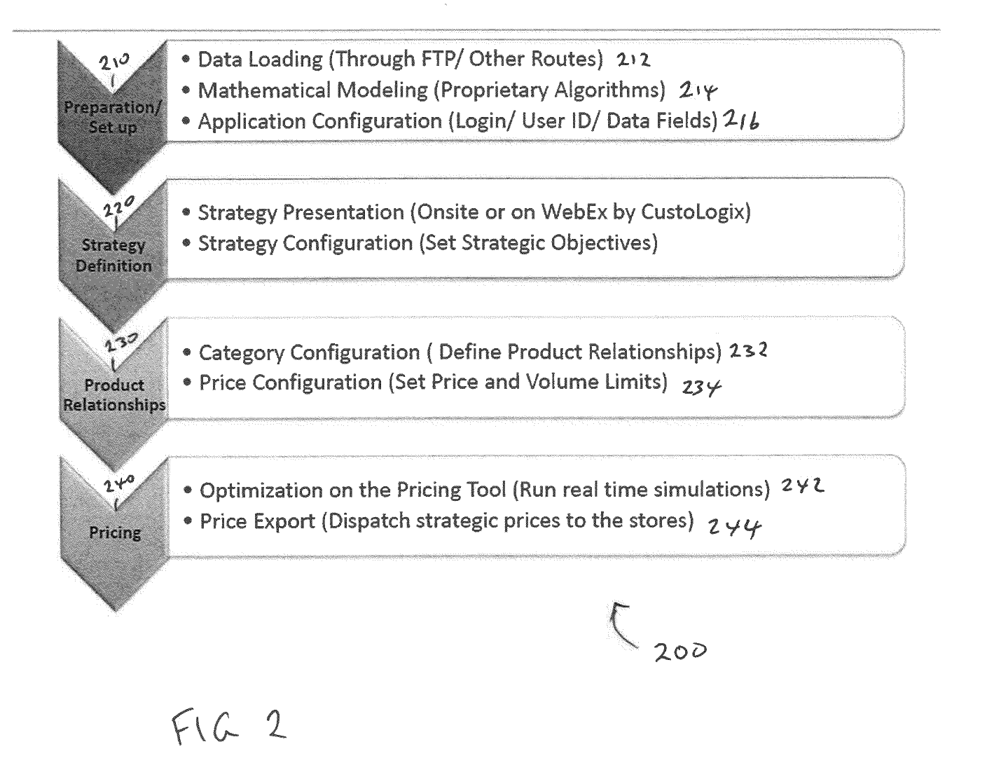

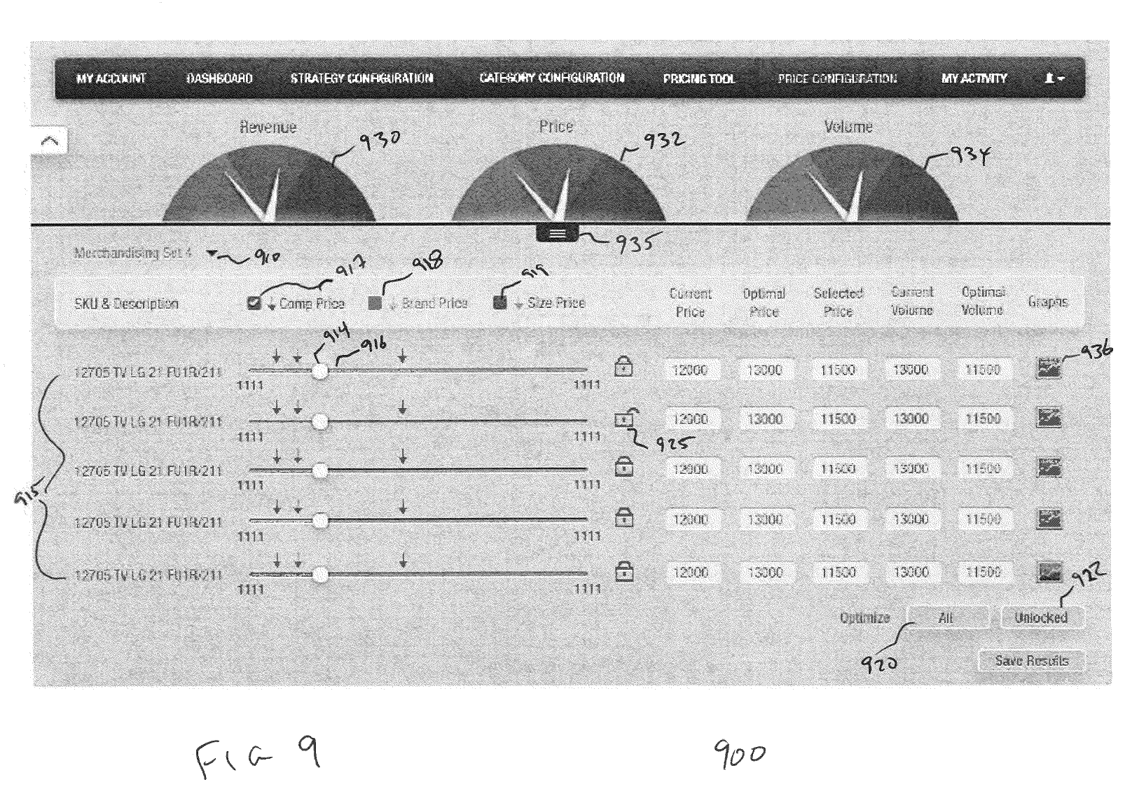

FIG. 2 illustrates a pricing optimization process 200 according to one embodiment. In preparation step 210, data is acquired and loaded into storage (e.g., storage 30, 34, etc) via FTP or other protocols as are well known in data loading step 212. Useful data from a retailer (e.g., retail chain) includes point of sale data, which might include a summary over a certain time period, typically a day or a week, as well as average pricing for products, average discounts for products, etc. Other useful retailer data might include transactional data, e.g., receipt level data, and competitive pricing information. Competitive pricing information can be downloaded from a retailer, or it can be obtained from a third party site or obtained from the web using a search bot, etc. Additional data loaded might include market level data, such as demographics data (e.g., zip codes), survey data, third party data, customer loyalty data, transaction level data (e.g., t-log), etc Mathematical modeling of the data occurs in step 214. For example, in one embodiment, coefficients 38 are generated based on the stored data and stored to a coefficient table 60. The coefficients are used in the pricing and volume optimization algorithms (e.g., during step 240 and/or to populate information in the pricing tool screen 900 of FIG. 9 prior to use of pricing tool 900 in step 240). For example and optimization equation may take the (simplified) form of y=ax+by+cz, where x, y and z are variables such as quantity sold, day of the week and seasonality, and a, b and c are product coefficients (typically positive or negative numerical values as are well known). In certain embodiments, variables, or factors to be considered in the various product pricing optimization algorithms might include some or all of the following: seasonality. Trend, price elasticity, promotion lift, day of the week, time of the year, substitutability, shopping criterion, brand preference, size hierarchy, live price, brand hierarchy, feature hierarchy, competitive prices desired pricing strategy, demographics and weather. As will be discussed in more detail herein, the coefficients may be modified in real time based on user input through the various user interface elements described herein, such as input identifying brand hierarchy, or size hierarchy, or feature hierarchy, etc., to optimize pricing for a product or merchandising set of products in a product category.

In step 216, the application is configured for the end user entity such as a retail company or retailer. For example, the application limits and goals for each category may be defined based on analytical insights delivered during the modeling phase and also based on the expert recommendations of retail strategy consultants. Also, output screen configuration may occur here, e.g., decisions made as to what information may be displayed in various graphs and windows discussed herein.

In step 220, strategy goals or objectives are set or defined for product categories. In one embodiment, strategy goals are defined by an administrative level user and/or by a consultant familiar with the POS protocols. Strategy goals in one embodiment include a primary objective and a pricing strategy. Examples of a primary objective for a product category might be to increase revenue, to increase profit or to increase or decrease volume. Examples of pricing strategy objectives might include everyday low price (EDLP), high-low (HL), Loss Leader, Cost Plus, Premium Pricing, Penetration Pricing, and Predatory Pricing, and other pricing objectives as are well known to one skilled in the art. In certain embodiments, the set strategy objectives are used in the underlying pricing optimization algorithm as a parameter(s) and/or a constraint(s).

In step 230, product categories are defined and product relationships within product categories are defined. Examples of product relationships include how products are shopped by consumers, e.g., based on brand, size, features, etc, how different brands are perceived by consumers. In step 234, price change and volume change limits are defined. For example, a user can define minimum and maximum changes allowable relative to current levels when optimizing product price and volume recommendations.

In step 240 POS generates and displays optimized product pricing and volume levels for product categories based on the various product relationship parameters, the price and volume change limits and a defined time frame in which the products are to be sold. Users are advantageously able to override the recommendations by modifying some or all of the displayed price and volume levels and, in real time, receive revised optimized pricing and volume recommendations for some or all of the displayed products. For example, in one embodiment, a user can modify price and volume levels for certain displayed products, select that certain displayed products be locked from further modification, and in real time the POS will present modified price and volume levels for the unlocked products. In step 244, the recommendations (e.g., price and volume levels) are exported as desired, e.g., via pdf or other document format to a store manager.

Various embodiments and aspects of process 200 will be described with reference to the user interface display screens shown in the following figures. As will be appreciated by one skilled in the art, the user display screens presented herein allow users to actively interact with POS 16 and modify or define the various input parameters, e.g., product categories, merchandising sets, product relationships, price and volume change limits, etc.

### User Interface and Detailed Process Flow

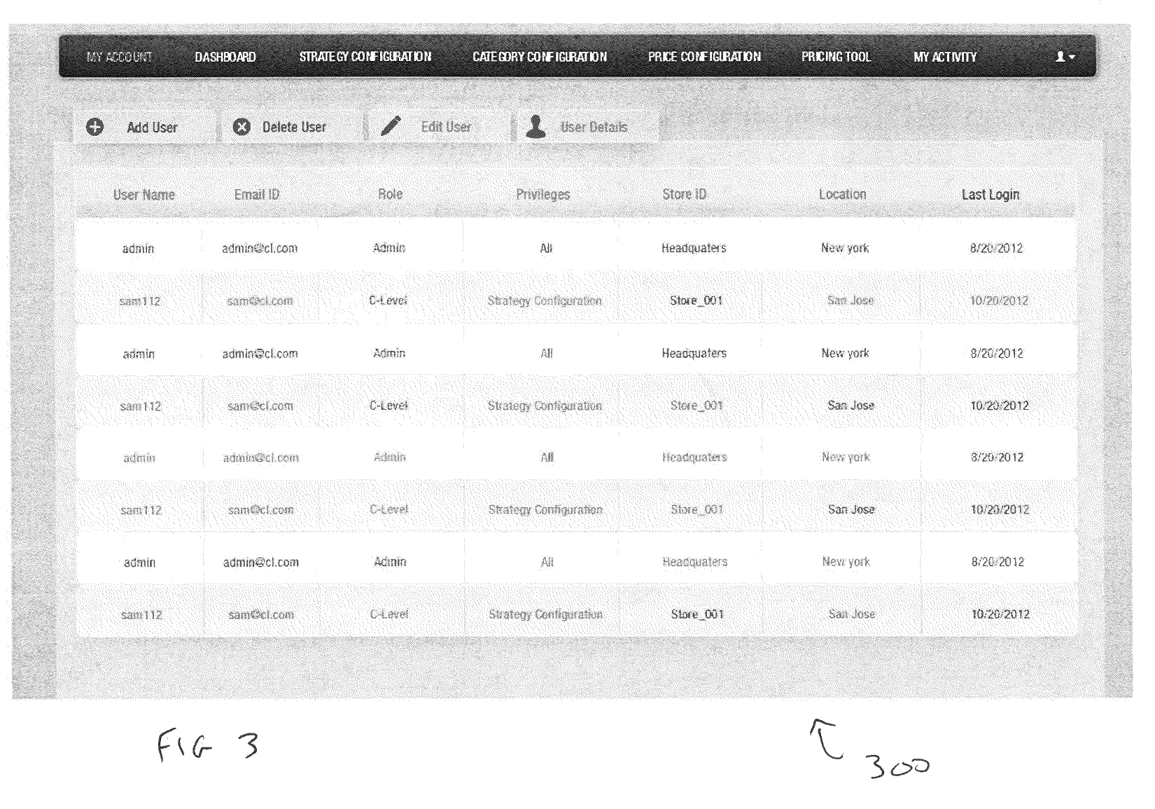

FIG. 3 illustrates a user administration display screen according to one embodiment. As shown, screen 300 displays data available in a user login database and includes functionality that allows a user (e.g., admin user) to add and delete users and define the login and accessibility to POS 16 to the various users. For example, the users' roles and privileges/permissions can be defined and other user information available from user database, such as login information, email address, store ID, etc can be shown.

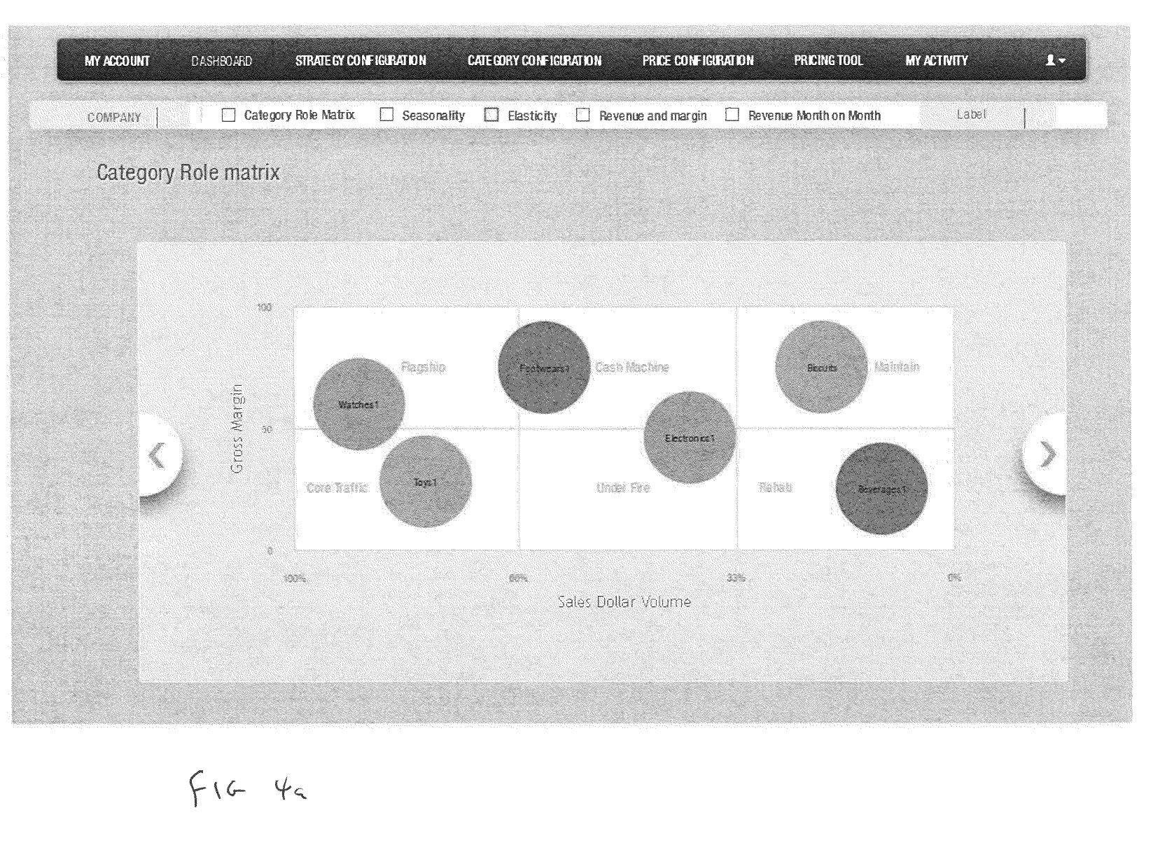

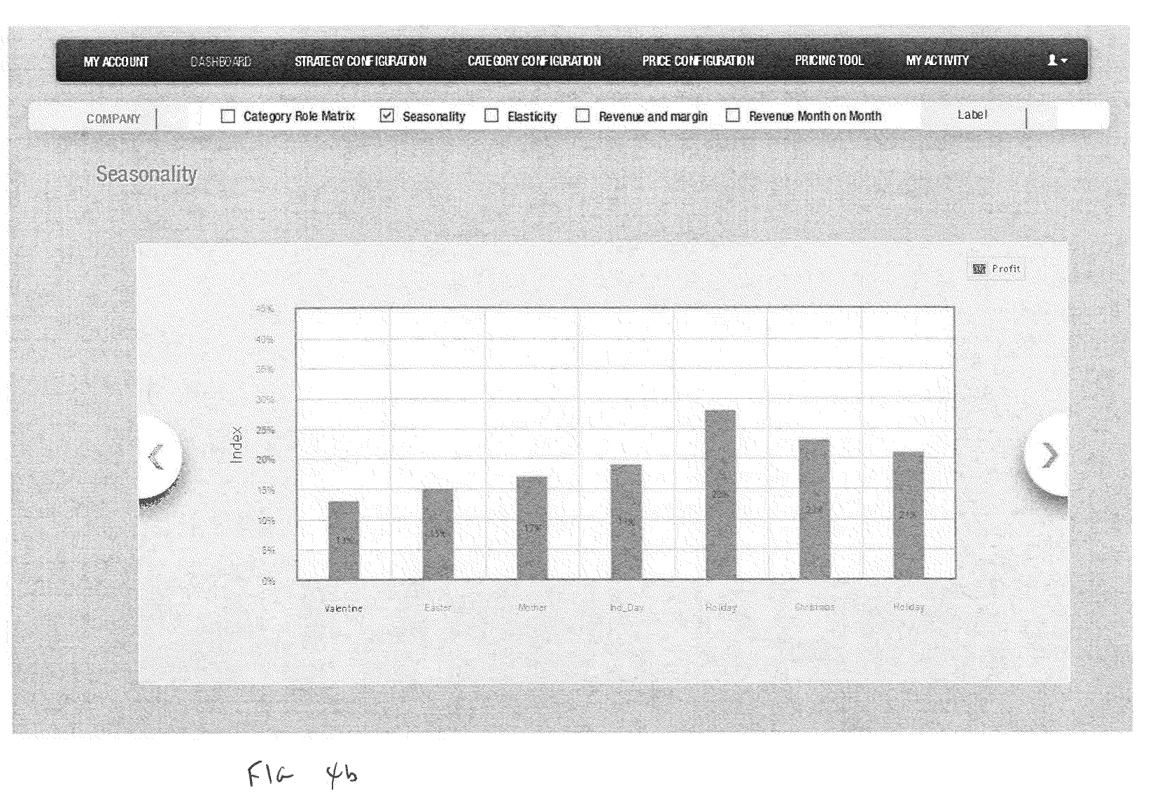

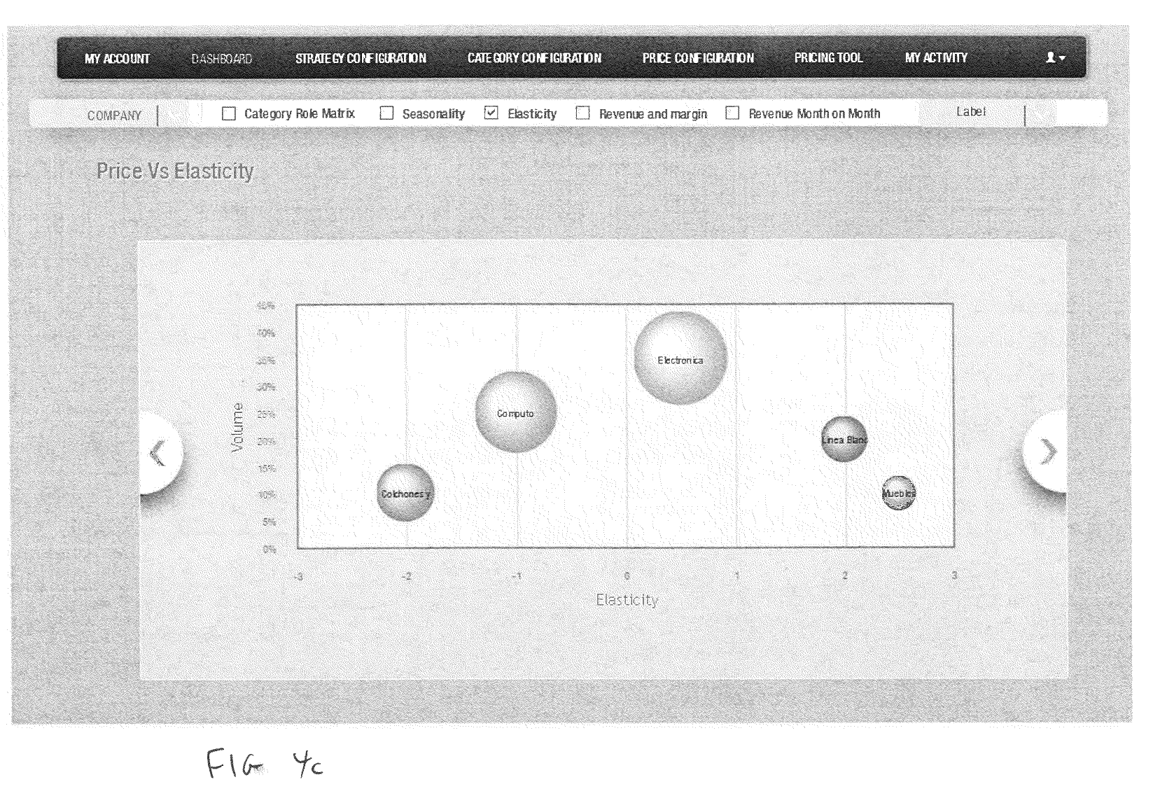

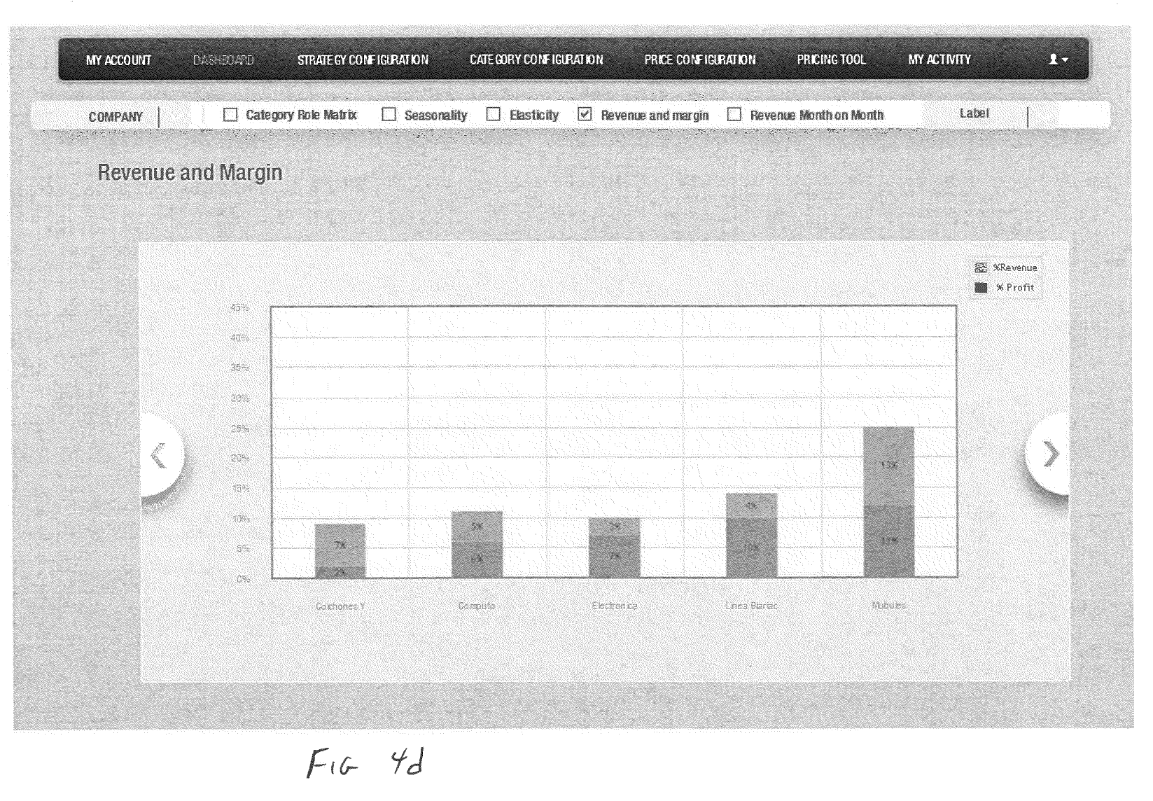

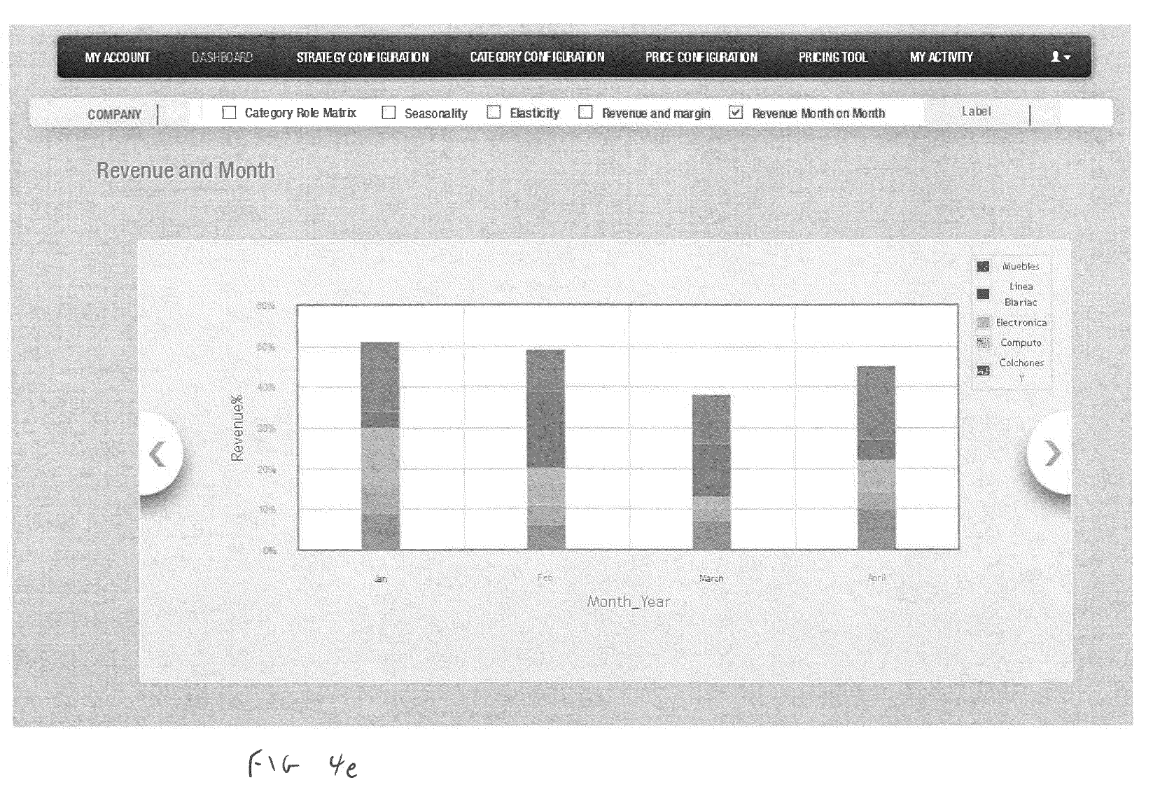

FIGS. 4a-4e illustrate a company level dashboard display 400 according to one embodiment. FIGS. 4a-4e show a series of available reports for a company/retailer based on the data downloaded from that company. These reports provide information to aid in understanding the company and product categories to help users make informed business decisions. The various available reports/graphs include:

FIG. 4a: Category Role Matrix: Shows the retailer's category and subcategory mixes

FIG. 4b: Seasonality: Explains the influence of seasonality with respect to holidays on the overall sales

FIG. 4c: Price v. elasticity

FIG. 4d: Revenue: Shows the revenue share of each category and subcategory; Margin: Shows the margin share of each category and subcategory

FIG. 4e% Share of Category/Subcategory: Shows the % share of each category/subcategory over months

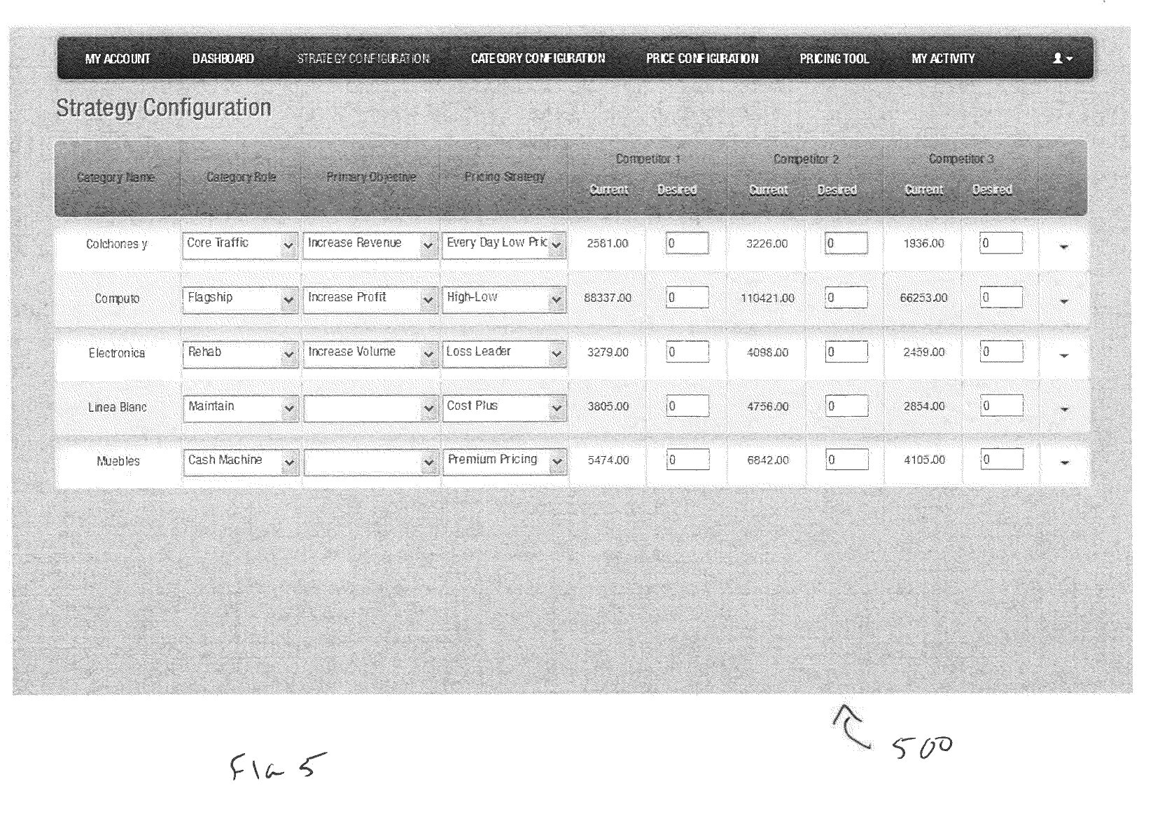

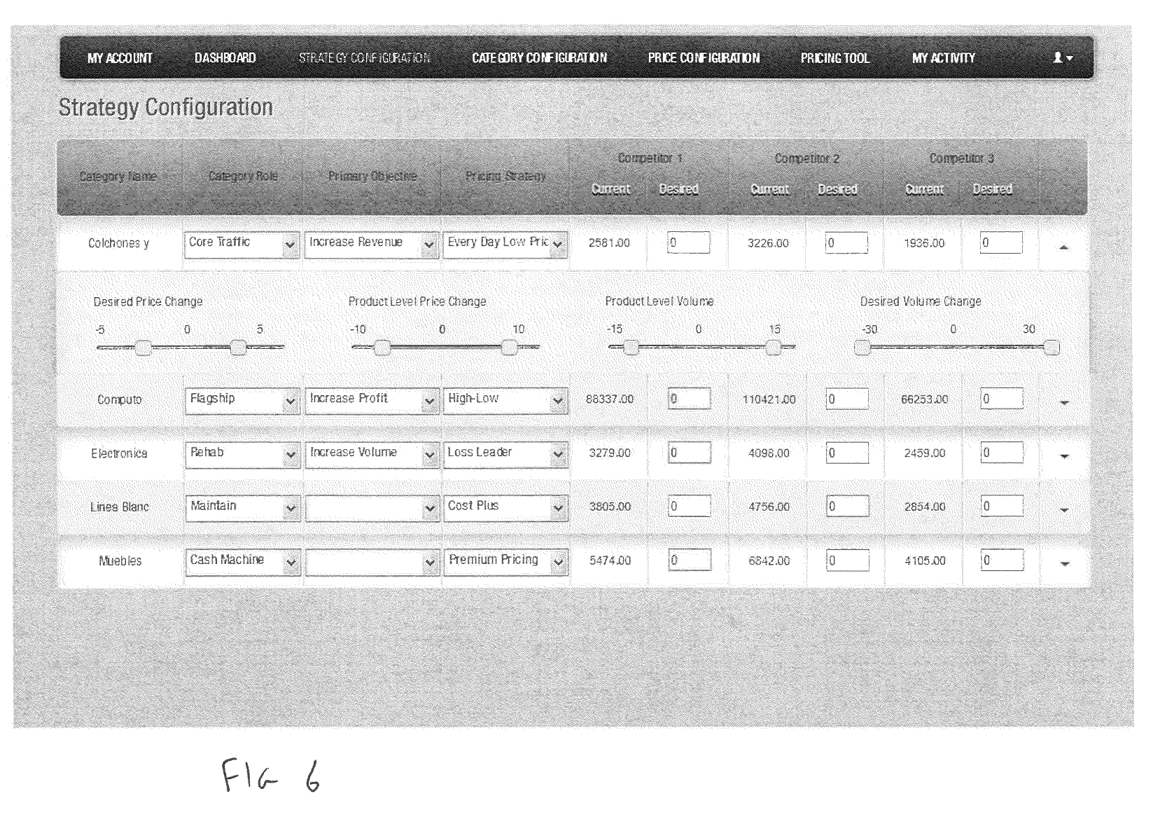

FIG. 5 illustrates a strategy configuration screen display 500 according to one embodiment. Screen 500 helps retailers make and manage strategy configuration decisions. Screen 500 enables a user (e.g., retailer) to review competitors' price information and define strategies, and to set limit changes for price and volume at category and product levels. The screen shows category name, its role, allows a user to set a primary objective of the category (e.g., to increase or decrease revenue, profit or volume), to set a pricing strategy (e.g., EDLP or no EDLP), and to review and set prices based on competitors' prices. Screen 500 also allows a user to set for category level and product level the desired price and volume change limits as shown in FIG. 6, which illustrates a strategy configuration screen display including change limit selectors according to one embodiment. Outputs to POS 16 include the Primary Objective, Pricing Strategy, Category Level Price Change Limits, Category Level Volume Change Limits, Product Level Price Change Limits and Product Level Volume Limits. Price and volume change limits may be defined by percentage changes relative to the current value, or based on an absolute difference relative to the current value.

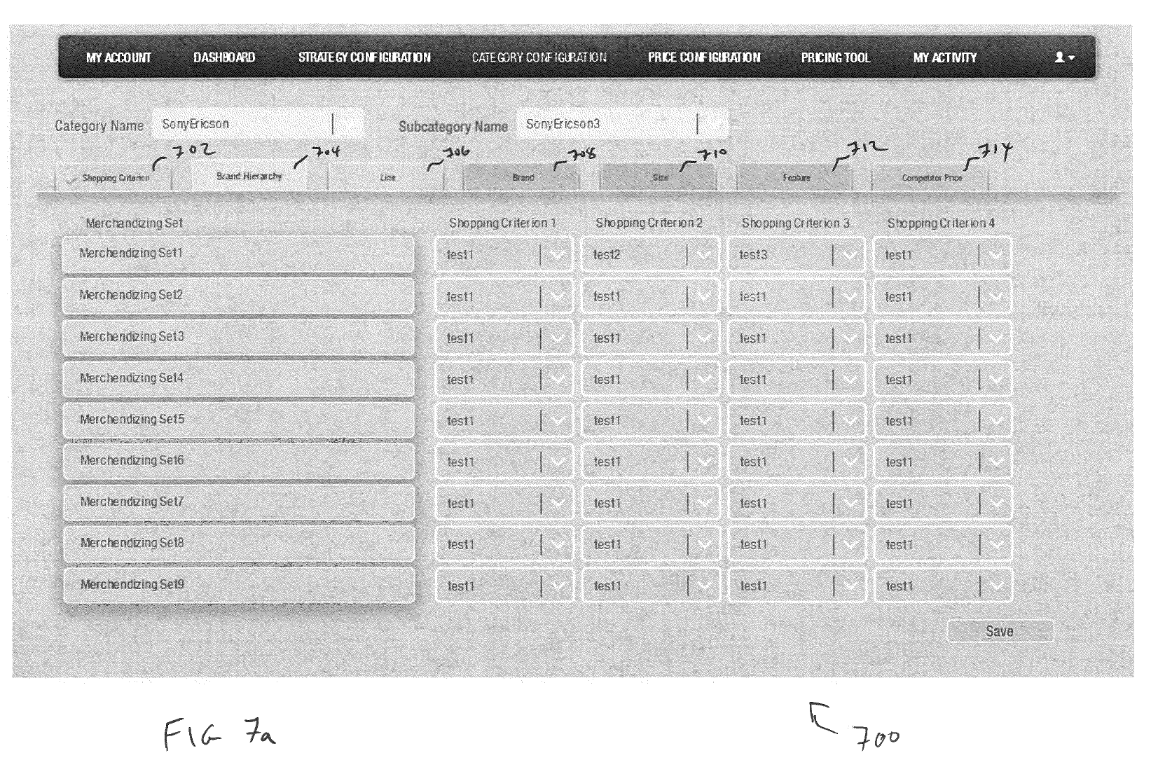

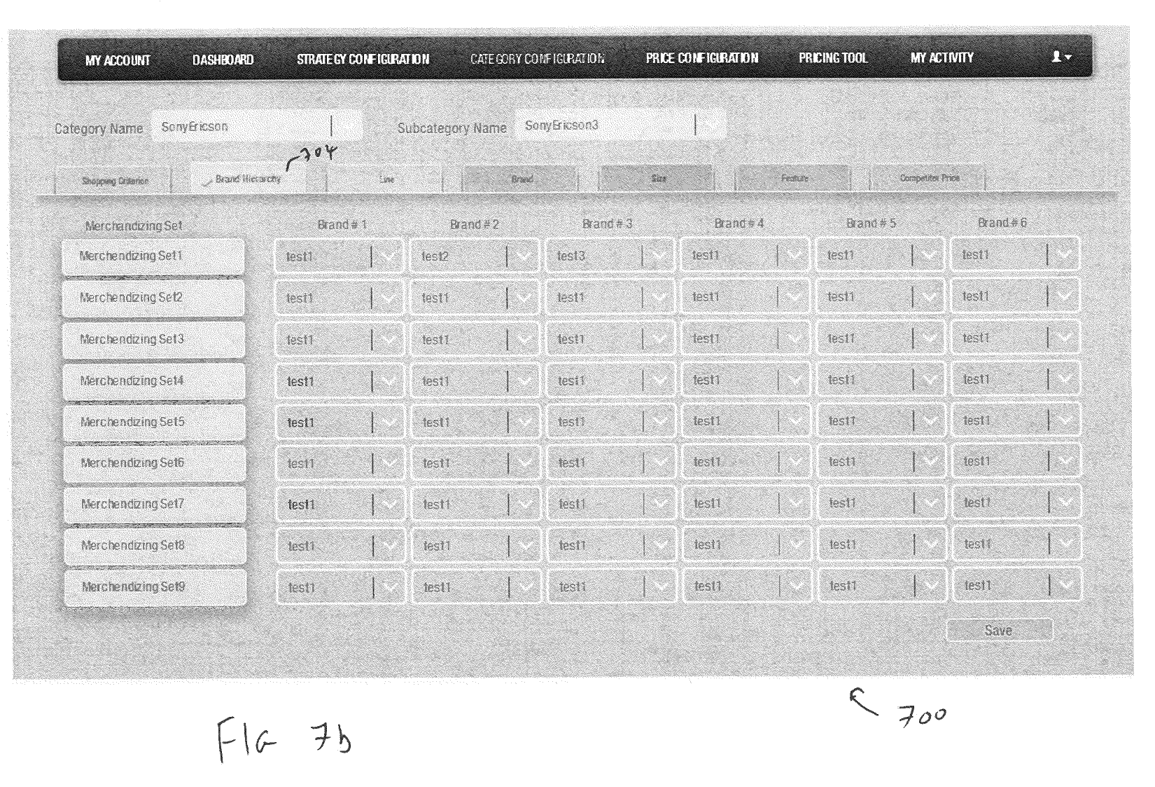

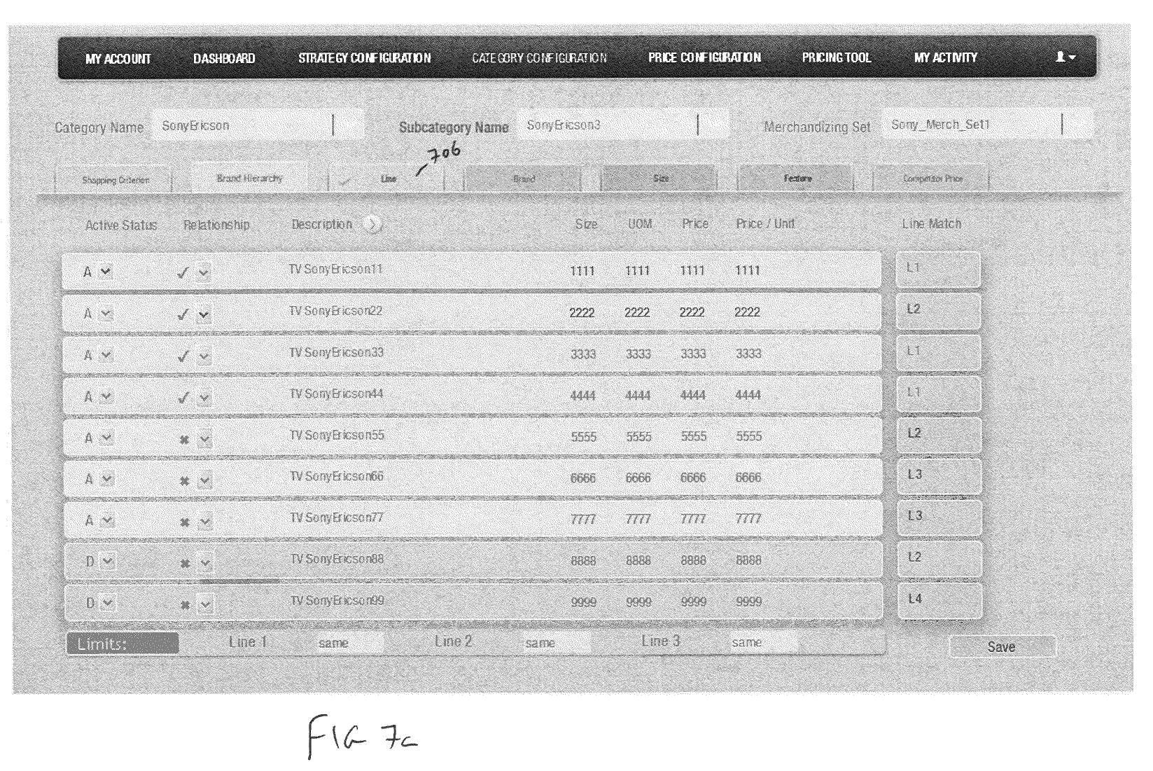

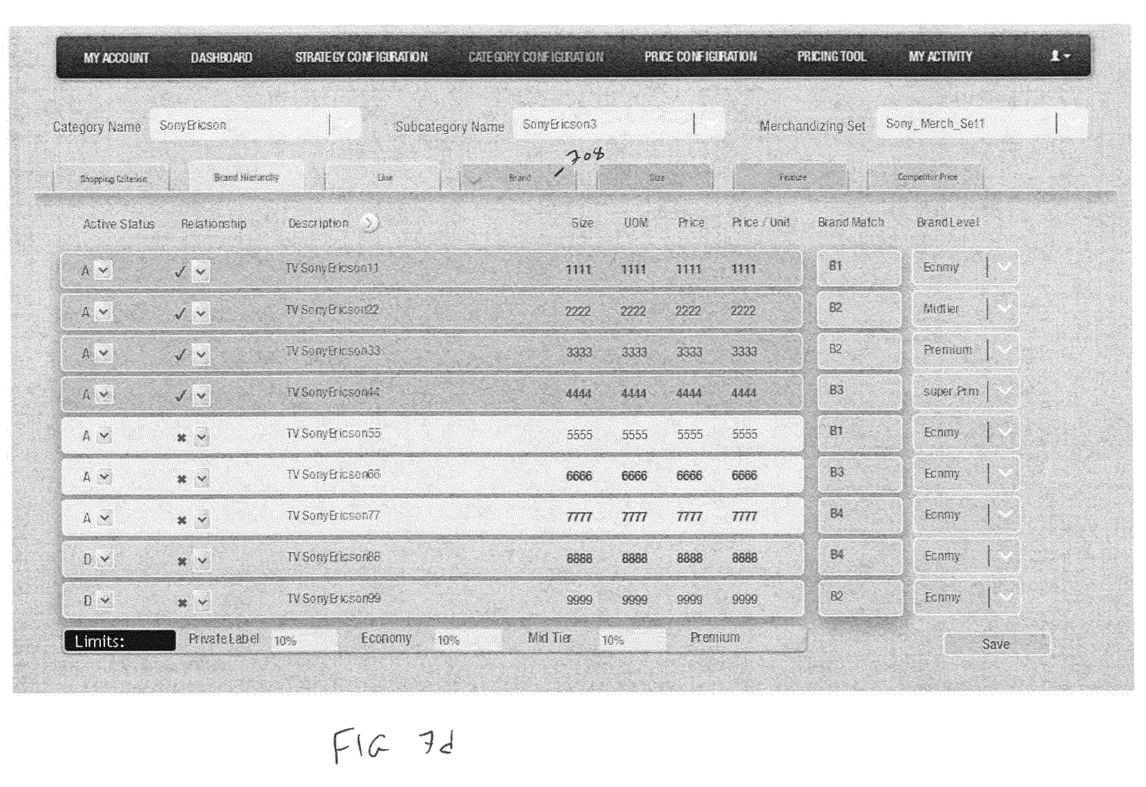

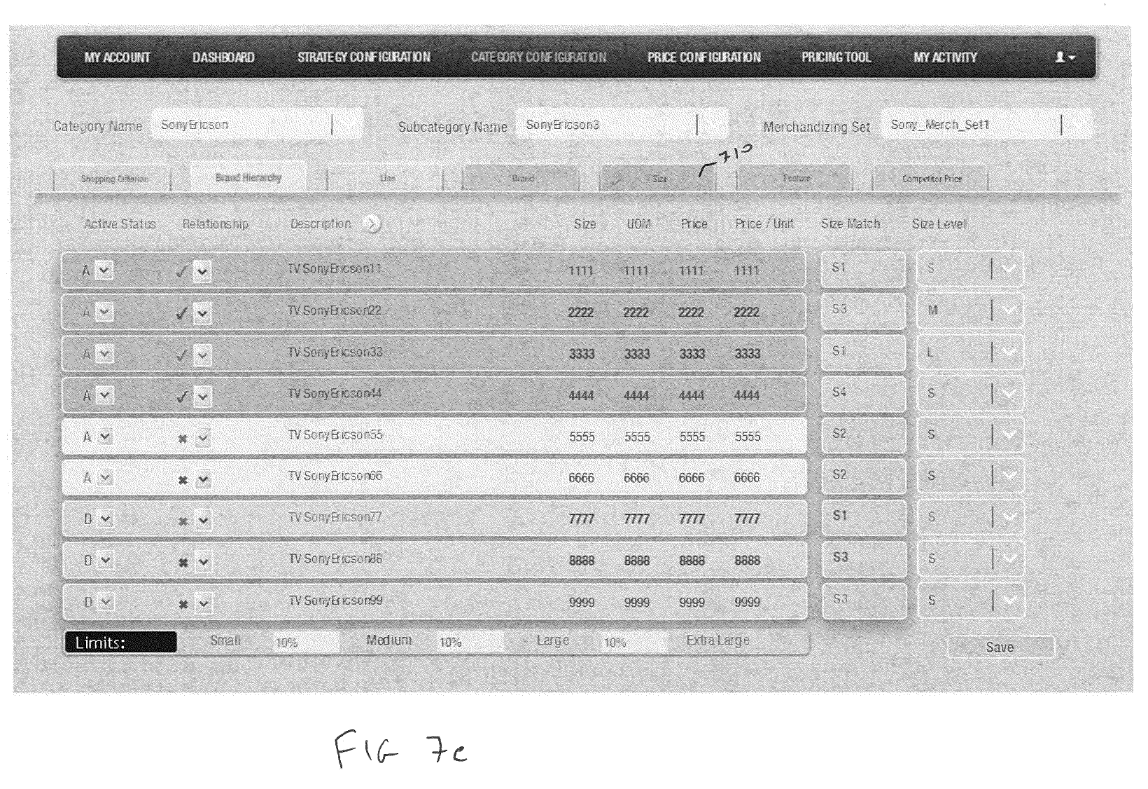

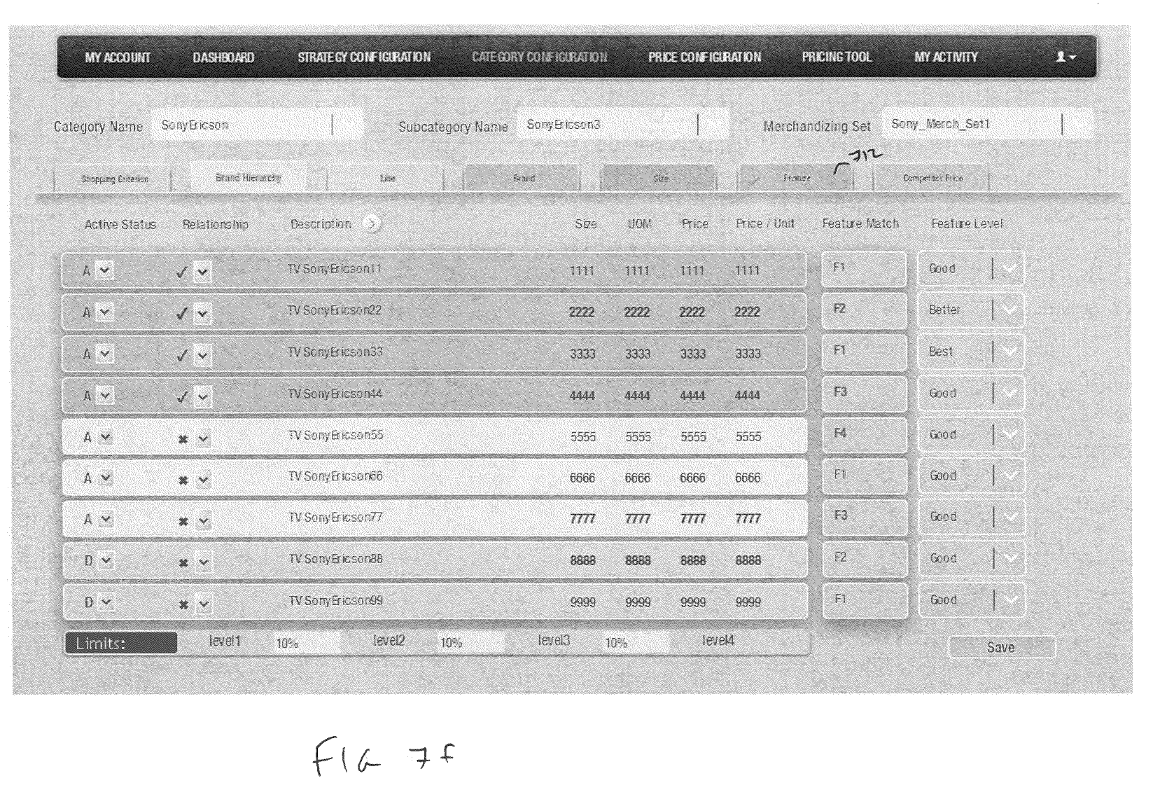

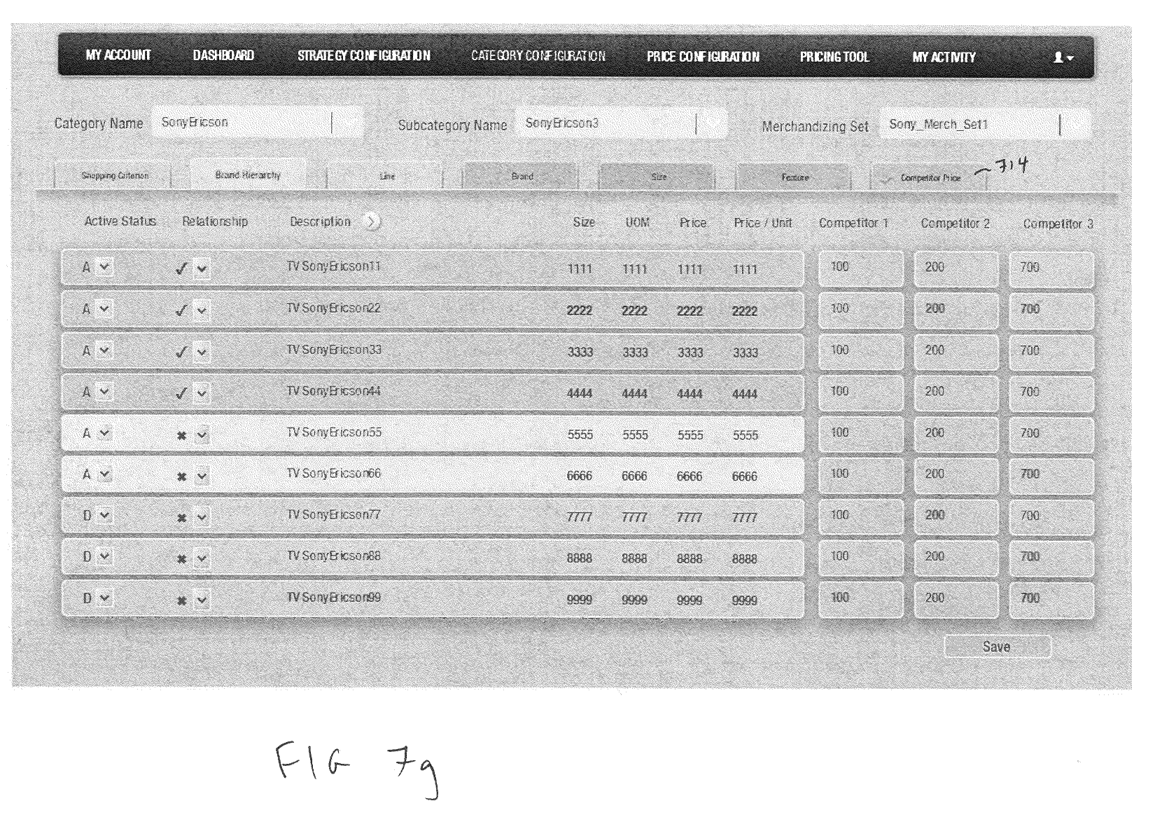

FIGS. 7a-7g illustrate a product category configuration screen display 700 according to one embodiment. Category configuration screen 700 presents a series of tabs that allow a user to establish a shopping criteria and pricing relationships between like products with different sizes, different brands, similar features, and similar products within the same product group. In one embodiment, screen 700 presents tabs for various parameters including shopping criterion tab 702, brand hierarchy tab 704, line tab 706, brand tab 708, size tab 710, feature tab 712 and competitor price tab 714. Additional or different parameter tabs may of course be used.

When selected, the shopping criterion tab 702 displays the customers shopping behavior for a product category in graphical representation based on various criterion like quality, quantity, cost, packaging, aesthetics etc. As shown in FIG. 7a, a user has selected shopping criterion tab 702 (as indicated by the check mark by the shopping criterion tab 702), which allows a user to define how a product category, or how merchandising sets within a product category, are shopped based on various criterion. For example, a user may define a certain merchandising set in a product category as being shopped by consumers based on brand over size over features over price, in that order, or a certain merchandising set in a product category may be defined as being shopped based on price first, then size, then by brand. In one embodiment, a hierarchical order of at least two product relationship parameters is input by a user using the shopping criterion dropdown selectors. In certain aspects, at least three product relationship parameters are input. For example, in shopping criterion 1, the user may select the “brand” parameter (“test 1” in FIG. 7a, in the shopping criterion 2, the user may select the “size” parameter (“test2”) and in the shopping criterion 3, the user may select “feature” (“test 3”).

When selected, brand hierarchy tab 704 displays the list of brands in hierarchical order based on the customers' perspective in graphical. As shown in FIG. 7b, a user has brand hierarchy tab 704, which allows a user to define how brands in a product category, or in merchandising sets within a product category, are perceived by consumers. For example, the user may, for a product category, select an order in which various brands may be perceived. Certain brands may be more desirable to consumers for certain products or product types. For example, Electronics Company A may be perceived as higher quality than Electronics Company B for tablets and laptops, whereas Electronics Company C may perceived as higher quality for cell phones or smart phones than Company A or Company B. Such possible consumer perceptions may be captured using the hierarchical order information input into screen 700 using the brand hierarchy definition functionality.

When selected, Line tab 706 allows a user to define which products belong to the same line of products. For example, the related line match of the SKU selected is displayed under matching product details and it can be changed by the user.

When selected, Brand tab 708 allows a user to define brand relationship information. Such information, in one embodiment, includes pricing differences between similar or like products of different brands. For example, a user may specify that sodas sold by Company X are always a certain percentage (e.g., 5% or 10%) higher in price that sodas sold by Company Y. As shown, limits can be set based on brand level as shown. In this example shown, for a product category, a brand level of Economy is always priced 10% lower than a brand level of mid-tier, which is always priced 10% lower a premium brand level. Values may be absolute values or percentage values, and may represent absolute or percentage limits (e.g., always 10% v. at least 10%, or always $1 difference v. at least $1 difference). In one embodiment, when the brand tab is selected, the related brand match of the SKU selected is displayed under matching product details and it can be changed by a user.

When selected Size tab 710 allows a user to specify size relationship information, e.g., how size differences may impact pricing. For example, a user may specify that where a 1 liter soda is sold for $1, a 2 liter soda is sold for an amount less than $2. As shown, limits can be set based on size level as shown. In this example shown, for a product category, a size level of small is always priced 10% lower than a size level of medium, which is always priced 10% lower a large size level. Values may be absolute values or percentage values, and may represent absolute or percentage limits (e.g., always 10% v. at least 10%, or always $1 difference v. at least $1 difference). In one embodiment, when the size tab is selected, the related size match of the SKU selected is displayed under matching product details and can be changed by the user.

When selected, Feature tab 712 allows a user to specify feature relationship information, e.g., how different features may impact pricing. For example, a user may specify that a 12 oz can of soda be priced 10% below a 12 oz bottle of soda. As shown, limits can be set based on feature identifiers (identified as “levels” in FIG. 7f) as shown. In this example shown, for a product category, a feature level of good is always priced 10% lower than a feature level of better, which is always priced 10% lower a best feature level. Values may be absolute values or percentage values, and may represent absolute or percentage limits (e.g., always 10% v. at least 10%, or always $1 difference v. at least $1 difference). In one embodiment, when the feature tab is selected, the related feature match of the SKU selected is displayed under matching product details and it can be changed by the user

When selected, Competitor Price tab 714 allows the user to specify competitor pricing information. Such information can be pre-populated, e.g., based on the data fed in step 210 of process 200. The user may adjust pre-populated data as desired and can enter information where none may be present. In one embodiment, when the competitor price tab is selected, the related competitor's price of the SKU is selected.

Output to POS 16 from user input using screen 700 and its various tabs includes a shopping criterion, brand hierarchy information, line relationship information, brand relationship information, size relationship information, feature relationship information and competitor price information.

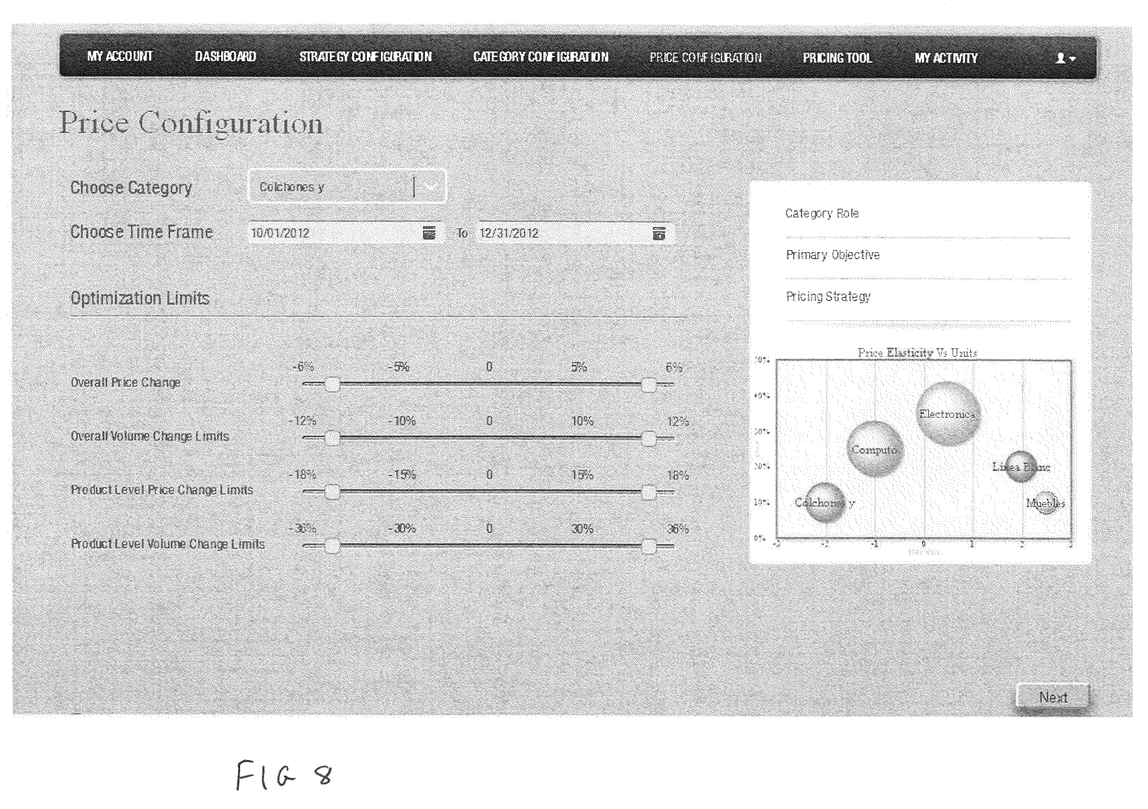

FIG. 8 illustrates a price and volume configuration screen display 800 according to one embodiment. Screen 800 allows a user to select a category and an optimization time period, e.g., the time frame in which products within the category are to be sold. Screen 800 also allows a user to set limits for category level and product level price and volume changes. If a user (e.g., a store manager) overrides the limits previously set by a user with a higher permission level, then an alert will be shown. Outputs to POS 16 include the product category, an optimization time period, category level price change limits, category level volume change limits, product level price change limits and product level volume limits.

FIG. 9 illustrates a pricing optimization modification screen display 900 according to one embodiment. Screen 900 allows a user to configure and optimize pricing and volume information for a merchandising set of products. Based on the category selected, the merchandise set is auto populated with a drop down menu option 910 that allows the user to select from among many different merchandising sets for the particular product category. As shown, merchandising set 4 has been selected, and products in merchandising set 4 are displayed in the portion 915 of window 900. In one embodiment, each product has a respective slide bar 916 with a slide selector element 914 placed at the optimized price. In one embodiment, screen 900 also include selectable indicators 917, 918 and 919, which provide links to prices of other competitors for the product, prices of other brands and prices of different product sizes for the same brand, respectively. As shown in FIG. 9, Competitor price indicator 917 has been selected and arrows representing competitor pricing information are displayed along the slide bar 916 for the displayed products. The arrows may be displayed in different colors, for example, depending on the indicator it is associated with.

In one embodiment, for each displayed product, the current price, optimal price, selected price, current volume and optimal volume are downloaded from POS 16 and displayed in table form as shown. When screen 900 is initially selected, the optimal price and optimal volume as determined by POS 16 are displayed for each product in one embodiment. Initially the Selected price column will be at the optimal price (and hence the slide selector element 914 will be positioned at the appropriate position along the slide bar to reflect this price). The Current Price column displays the current retail price of the product (SKU).

In one embodiment, a user is able to enter or adjust values in the Selected Price column, e.g., manual entry of price values. Upon entering or changing in the Selected Price Column these values, the slide selector element 914 changes appropriately. Alternatively, the user can manipulate slide element 914 to the desired (new) Selected Price. After changing the desired Selected Price values, the user has the ability to re-run the pricing optimization algorithms by selecting the Optimize All selector 920. Upon selection of the Optimize All button 920 a solver function is run in real time at the backend (POS 16) and the optimized price and volume information for the products is modified and the resulting optimal price and volume information is displayed. In this manner, a change to one or more prices in the Selected prices column represents a change or adjustment of the displayed optimized pricing and volume information for the displayed products. In one embodiment, the user is able to select to exclude products for which (re-) optimization will occur. In this embodiment, selectable lock indicators 925 are displayed next to each product. Upon selection of one or more lock indicators 925 by a user, the associated product(s) will be locked. The user may then select the Optimize unlocked products button 922, at which time a solver function is run in real time at the backend (POS 16) excluding changes to the locked products (e.g., the optimized pricing and volume information for all but the locked products may be modified) and the resulting optimal price is displayed in this column. In certain aspects, the solver function optimizes the price and volume information so that as a combination, the merchandising set, or the category will result in maximized profit (or whatever other metric the previously set strategic goal my dictate).

In one embodiment, the maximum and minimum scale for the slide bar 916 is ±25% of the current price of that product.

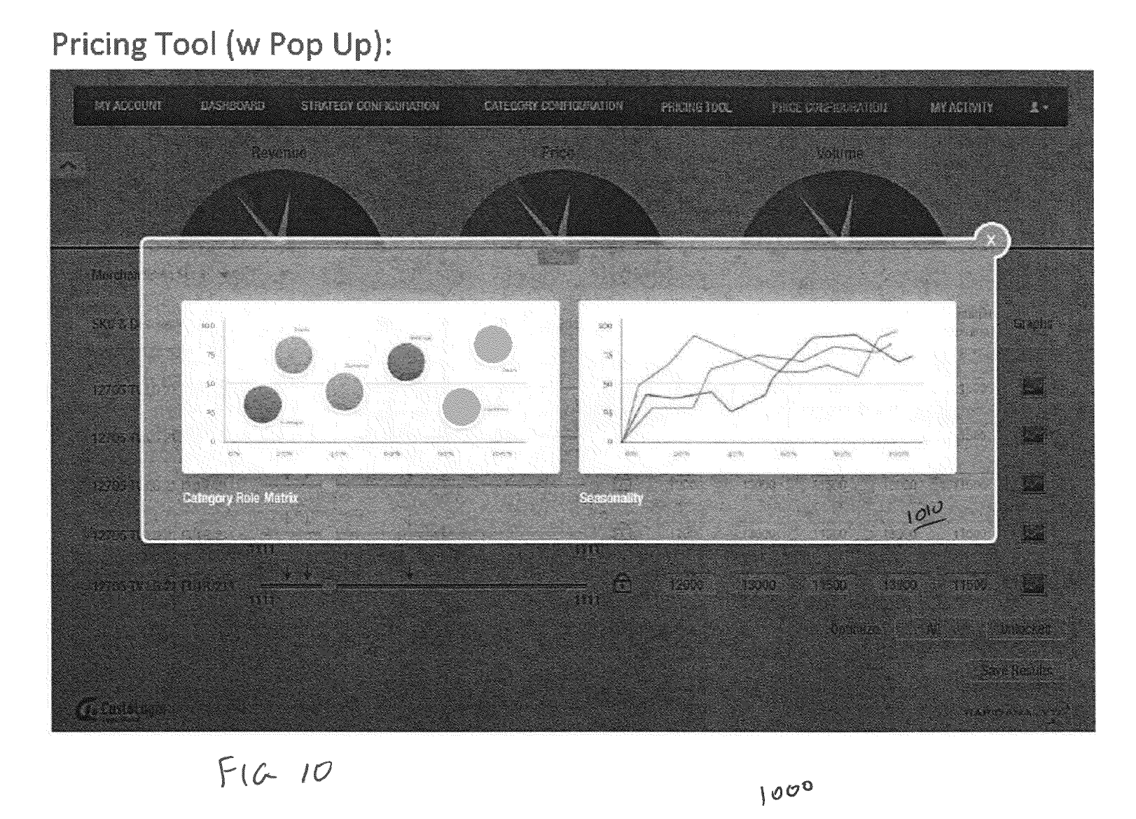

In one embodiment, screen 900 includes a selector 936 fro each product to provide useful information related to that product. For example, FIG. 10 shows a screen 1000 displayed upon user selection of an element 936. As shown, graphs depicting information pertinent to that product are shown in an overlay window 1010. Such graphs might include seasonality information for the product, category role information for the product. Other graphical information that may be displayed in window 1010 might include forecast information for the product, product life cycle information or any other information that could be useful to a user. Configuration of what information may be displayed here is done in certain aspects in configuration step 216 of process 200.

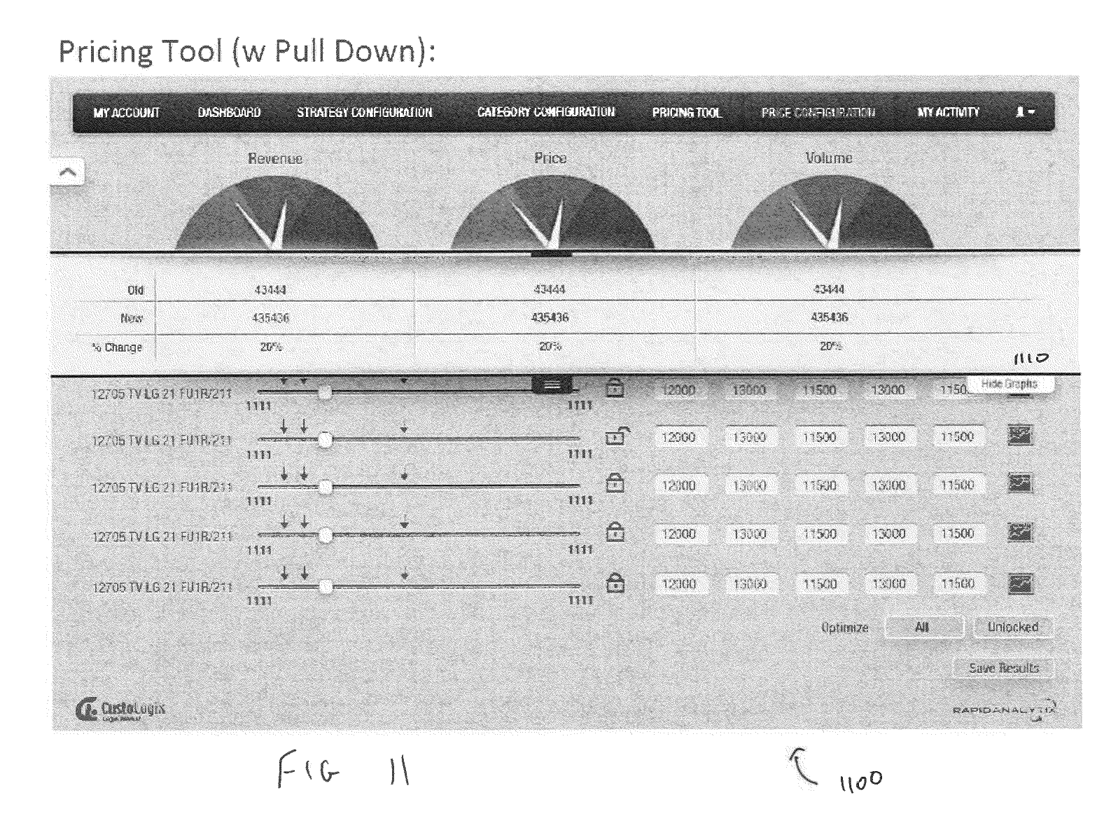

In one embodiment, screen 900 also includes informative dial graphs or other useful information. For example, a dial graph 930 may be included to depict or represent Optimal and Current Revenue of the merchandizing set for the selected prices, dial graph 932 may be included to depict or represent Optimal and Current Profit of the merchandizing set for the selected prices, and dial graph 934 may be included to depict or represent Optimal and Current Volume of the merchandizing set for the selected prices. If changes to the optimized values are received, e.g., responsive to a user adjusting selected price values and re-optimizing, the changes are automatically reflected in the displayed dial graphs. In one embodiment, a selector element 935 allows a user to obtain numerical values of the information shown in the graphs 930, 932 and 934. FIG. 11 shows a screen 1100 including numerical information displayed in the dial graphs in the form of window 1110. Window 1110 may be in the form of an overlay window, pop-up screen or a pull-down type window element.

Outputs of user interaction with screen 900 may include product (e.g., product identifier such as SKU), product description, Optimal Prices, Current Prices, Forecast Volume, Current Volume and Forecast Graphs.

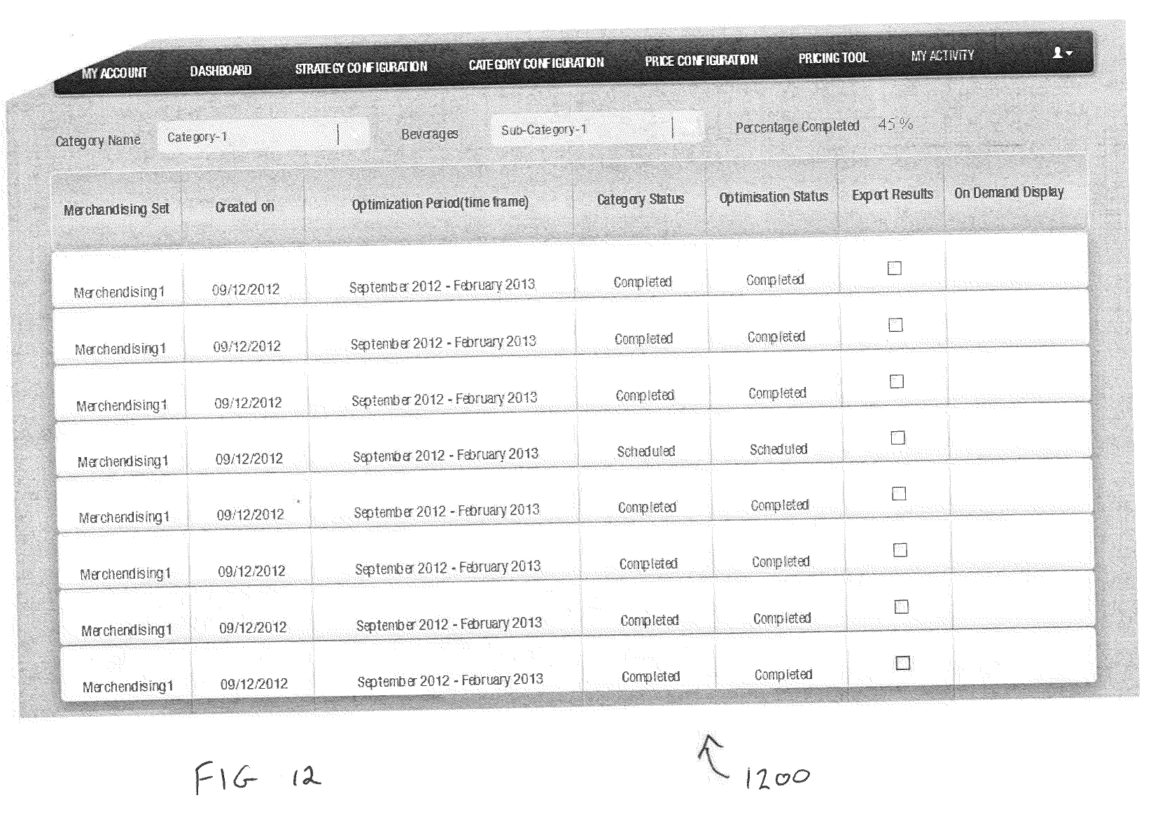

FIG. 12 illustrates an activity display screen 1200 according to one embodiment. When My Activity tab is selected, screen 1200 is displayed. Screen 1200 allows a user to track optimization activity. For example, as shown, a user is able to select among product categories and sub-categories, and for the selected information, useful information regarding the status of optimization is displayed. Examples of useful information that may be displayed include the category status, the status of optimization for the category/sub-category/merchandising set, the selected optimization time period for the category/sub-category/merchandising set and date information, such as when a merchandising set or sub-category may have been created. Screen 1200 also allows the user the ability to export optimization information (e.g., recommended price and volume levels). For example, a high level user, such as a regional sales manager may select to export optimization information to a store manager or other user. Export of information can be by way of FTP transmission, email transmission or other sending methodology, of a pdf document, Excel document, word document, a document in any desirable document format. One suitable export form might be to print to a printer, such as a remote printer in the store manager's office or to a local printer.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the embodiments (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All method or process steps described herein can be performed in any suitable order unless otherwise indicated herein or otherwise clearly contradicted by context. The use of any and all examples, or exemplary language (e.g., “such as”) provided herein, is intended merely to better illuminate the various embodiments and does not pose a limitation on the scope of the various embodiments unless otherwise claimed. No language in the specification should be construed as indicating any non-claimed element as essential to the practice of the various embodiments.

Exemplary embodiments are described herein, including the best mode known to the inventors. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, all modifications and equivalents of the subject matter recited in the claims appended hereto are included as permitted by applicable law. Moreover, any combination of the above-described elements in all possible variations thereof is encompassed unless otherwise indicated herein or otherwise clearly contradicted by context.

1. A computer-implemented method of optimizing product pricing information based on product relationship parameters, the method comprising the steps, implemented in a processor, of:
receiving a specification of product price and volume change limit parameters for a product category comprising merchandising sets of two or more product types;
receiving a specification of a shopping criterion defining how each merchandising set in said product category is shopped by consumers;
receiving a time frame specification that specifies a time frame for selling products in said product category;
determining optimized pricing and volume information for said products in said product category for said time frame based on the shopping criterion, the product price and volume change limit parameters and the time frame; and
causing said optimized pricing and volume information for said products in said product category to be displayed on a display device.

2. The method of claim 1, wherein the shopping criterion comprises a heirarchical order of at least two product relationship parameters, said product relationship parameters including brand relation information, size relation information, feature relation information and price relation information.

3. The method of claim 2, wherein the brand relation information specifies percentage pricing differences between different product brands.

4. The method of claim 2, wherein the price relation information includes competitive retail price information.

5. The method of claim 2, wherein the shopping criterion comprises a hierarchical order of at least three of said product relationship parameters.

6. The method of claim 1, further comprising: modifying in real time, and displaying, the optimized price and volume information for all displayed products in said product category responsive to receiving an adjustment of the displayed optimized pricing and volume information for one or more of said displayed products.

7. The method of claim 6, further comprising receiving input indicating a lock on changes to the optimized pricing and volume information for one or more of the displayed products, wherein modifying includes modifying the optimized price and volume for all but the one or more locked products.

8. The method of claim 6, wherein determining and modifying optimized pricing and volume information are based on maximized profit for said displayed products.

9. The method of claim 1, wherein the product category comprises two or more product subcategories, each subcategory comprising two or more merchanding sets.

10. The method of claim 1, further comprising receiving a specification of a set pricing strategy parameter, wherein determining optimized pricing and volume information is further based on the set pricing strategy parameter.

11. The method of claim 10, wherein the set pricing strategy parameter includes a parameter identifying a strategy selected from the group consisting of everyday low price (EDLP), high-low (HL), Loss Leader, Cost Plus, Premium Pricing, Penetration Pricing, and Predatory Pricing.

12. The method of claim 1, further comprising, for said product category, receiving a specification of a brand hierarchy identifying an order of a set of product brands, wherein determining optimized pricing and volume information is further based on the brand hierarchy.

13. A computer-implemented method of displaying, on a display, optimized pricing and volume information for products in a product category, the method comprising:
displaying a change limit parameter selection tool for adjusting product price and volume change limit parameters for a product category comprising merchandising sets of two or more product types;
displaying a shopping criterion tool for selecting a shopping criterion for said product category, said shopping criterion defining how each merchandising set is shopped by consumers;
displaying a time frame selection tool for selecting a time frame for selling products in said product category; and
displaying optimized pricing and volume information for products in said product category for said time frame, said optimized pricing and volume information being automatically determined based on a selected shopping criterion, selected price and volume change limit parameters and a selected time frame.

14. The method of claim 13, further comprising, for said product category, displaying a brand hierarchy selection tool for selecting a brand hierarchy identifying an order of a set of product brands, wherein said optimized pricing and volume information is further determined based on the brand hierarchy.

15. The method of claim 13, wherein the shopping criterion comprises a heirarchical order of at least two product relationship parameters, said product relationship parameters including brand relation information, size relation information, feature relation information and price relation information.

16. The method of claim 15, wherein the brand relation information specifies percentage pricing differences between different product brands.

17. The method of claim 15, wherein the price relation information includes competitive retail price information.

18. The method of claim 15, wherein the shopping criterion comprises a heirarchical order of at least three of said product relationship parameters.

19. The method of claim 13, further comprising: modifying in real time the displayed optimized price and volume information for some or all products in said product category responsive to receiving an adjustment of the displayed optimized pricing and volume information for one or more of said products.

20. The method of claim 19, further comprising receiving input indicating a lock on changes to the optimized pricing and volume information for one or more of the displayed products, wherein modifying includes modifying the optimized price and volume information for all but the one or more locked products.

21. The method of claim 19, wherein the displayed optimized pricing and volume information are determined and modified based on a maximized profit metric.

22. The method of claim 13, wherein the product category comprises two or more product subcategories, each subcategory comprising two or more merchanding sets.

23. The method of claim 13, wherein the displayed optimized pricing and volume information is further determined based on a set pricing strategy parameter.

24. The method of claim 23, wherein the set pricing strategy parameter includes a parameter identifying a strategy selected from the group consisting of everyday low price (EDLP), high-low (HL), Loss Leader, Cost Plus, Premium Pricing, Penetration Pricing, and Predatory Pricing.

25. The method of claim 13, wherein the product price and volume change limit parameters include a maximum allowed percentage increase and a maximum allowed percentage decrease for each of a price and a volume of a product in the product category.

26. A decision support system configured to optimize product pricing information based on product relationship parameters, the system comprising:
a display device; and
a processor adapted to:
receive a first specification of product price and volume change limit parameters for a product category comprising merchandising sets of two or more product types;
receive a second specification of a shopping criterion defining how each merchandising set in said product category is shopped by consumers;
receive a time frame specification identifying a time frame for selling products in said product category;
determine optimized pricing and volume information for products in said product category for said time frame based on the shopping criterion, the price and volume change limit parameters and the time frame; and
cause the optimized pricing and volume information for products in said product category to be displayed on the display device.

27. The system of claim 26, further comprising a memory device that stores the time frame specification and the first and second specifications.

28. The system of claim 26, wherein said processor is further adapted to receive a specification of a brand hierarchy identifying an order of a set of product brands for said product category, wherein determining said optimized pricing and volume information is further based on the brand hierarchy.

29. The system of claim 26, wherein the shopping criterion comprises a hierarchical order of at least two product relationship parameters, said product relationship parameters including brand relation information, size relation information, feature relation information and price relation information.

30. The system of claim 29, wherein the brand relation information specifies percentage pricing differences between different product brands.

31. The system of claim 29, wherein the price relation information includes competitive retail price information.

32. The system of claim 29, wherein the shopping criterion comprises a hierarchical order of at least three of said product relationship parameters.

33. The system of claim 26, wherein the processor is further adapted to modify in real time the displayed optimized price and volume information for some or all products in said product category responsive to receiving an adjustment of the displayed optimized pricing and volume information for one or more of said products.

34. The system of claim 33, wherein the processor is further adapted to receive input indicating a lock on changes for one or more of the displayed products, wherein modifying includes modifying the optimized price and volume for all but the one or more locked products.

35. The system of claim 33, wherein the displayed optimized pricing and volume information are determined and modified based on a maximized profit metric.

36. The system of claim 26, wherein the product category comprises two or more product subcategories, each subcategory comprising two or more merchandising sets.

37. The system of claim 26, wherein the optimized pricing and volume information is further determined based on a set pricing strategy parameter.

38. The system of claim 37, wherein the set pricing strategy parameter includes a parameter identifying a strategy selected from the group consisting of everyday low price (EDLP), high-low (HL), Loss Leader, Cost Plus, Premium Pricing, Penetration Pricing, and Predatory Pricing.

39. The system of claim 26, wherein the product price and volume (quantity) change limit parameters include a maximum allowed percentage increase and a maximum allowed percentage decrease for each of a price and a volume of a product in the product category.

40. The method of claim 1, wherein the product price and volume change limit parameters include a maximum allowed percentage increase and a maximum allowed percentage decrease for each of a price and a volume of a product in the product category.
